(19) United States
(12) Patent Application Publication
(10) Pub. No.: US 2013/0317756 A1
(43) Pub. Date: Nov. 28, 2013

(54) Method Of Deadtime Correction In Mass Spectrometry

(71) Applicants: Keith Richardson, New Mills (GB); Richard Denny, Staffordshire (GB); Martin Green, Cheshire (GB); Jason Lee Wildgoose, Stockport (GB)

(72) Inventors: Keith Richardson, New Mills (GB); Richard Denny, Staffordshire (GB); Martin Green, Cheshire (GB); Jason Lee Wildgoose, Stockport (GB)

(73) Assignee: MICROMASS UK LIMITED, Manchester (GB)

(21) Appl. No.: 13/977,861

(22) PCT Filed: Jan. 9, 2012
(86) PCT No.: PCT/GB12/50029

§ 371 Date: Aug. 16, 2013

Related U.S. Application Data
(60) Provisional application No. 61/434,510, filed on Jan. 20, 2011.

(30) Foreign Application Priority Data
Jan. 10, 2011 (GB) 1100300.1

(51) Int. Cl. H01J 49/00

(52) U.S. Cl. CPC H01J 49/0036
USPC 702/23

(57) ABSTRACT

A method of improving the fidelity of m/z dependent measurements for a species of interest in an analyte in a mass spectrometer, which method comprises the steps of acquiring raw data produced in a mass spectrometer, identifying a region within the raw data that relates to the species of interest, forming a mathematical model to calculate the joint probability distribution of the parameters effecting the m/z dependent measurements, analytically obtaining samples from the joint probability distribution to produce corrected or refined m/z dependent measurements with associated uncertainties.

This invention relates to a method for improving the fidelity of m/z dependent measurements such as mass and/or response measurements obtained in mass spectrometry equipment and particularly in such equipment using edge detecting ion detectors.

Mass spectral information corresponding to a single molecular species is commonly spread over multiple mass spectra. This is necessarily true of chromatographic experiments in which it is necessary to preserve separation and the spectra in question span a chromatographic peak. One might imagine that once a chromatographic peak has been identified, the optimal mass measurement strategy would be to sum the corresponding spectra and peak detect the result. There are at lease two reasons why this is not always true.

First, time to digital convertors (TDC) time of flight mass spectral data is currently subject to arrival rate dependent mass shifts due to (extending) dead time and TDC edge effects. By summing spectra time dependent intensity information that often allows an accurate mass measurement to be obtained is lost.

Secondly, interfering species can distort the mass measurement of the summed spectrum, while proper treatment of the individual spectra might allow an accurate mass measurement to be recovered.

Another technique that requires storage of separate spectra is Dynamic Range Enhancement (DRE) in which a mass spectrometer is configured to acquire data at multiple (known) attenuation levels. As the name suggests, this extends the dynamic range over which accurate mass (and intensity) measurements can be obtained.

The algorithm incorporated in a method according to the present invention addresses the problem of arriving at a single mass measurement using data from a predefined set of scans and mass window. In fact “accurate position” with respect to the native instrument acquisition grid rather than “accurate mass” will be addressed. The present invention may distinguish correction of detector effects and removal of interferences from calibration and lock mass correction. The accurate position in question will be calculated in units of native data channels (although the result will usually be non-integer).

Edge detecting time to digital converters (TDC) often are used to measure the arrival times of ions at detectors in mass spectrometers. These devices typically operate by recording the times at which the magnitude of the voltage output from the detector increases past a predetermined “TDC threshold” which is set at a value that is high enough to reject electronic noise, but low enough to allow detection of a large proportion of single on arrivals.

Unfortunately, in cases where the signal produced at the mass spectrometer's detector is high, the voltage output stays above the predetermined threshold, and so the mass spectrometer does not recognise the exact mass of the peak in question, or the intensity of that peak.

Existing techniques for measurement of peak properties in the resulting data involve steps such as averaging or summing the data and application of multidimensional filters to the data. These approaches are useful when the MS detection system is operating in an approximately linear regime. However, all practical detection systems display non-linear behaviour. For example all MS detectors have a saturation characteristic such that there is an upper limit on the ion arrival rate which will result in an output signal that scales in proportion.

In the case of LC analysis, it is often the case that as a particular species begins to elute, it will produce a small MS signal that is well within the linear range of the MS detection system. However, at a slightly later retention time, the signal might saturate the detector. Eventually the signal falls again and the response is once again linearly proportional to the underlying ion arrival rate.

A known method of processing this data involves discarding some of the spectra near the apex of the chromatographic peak. However this method suffers from drawbacks. Firstly, some of the available data is not used for mass measurement and, since the onset of TDC deadtime with ion arrival rate is gradual, the remaining spectra may not be free of deadtime especially if the chromatographic peak width is small compared with the spacing of the acquired spectra. Secondly, this approach does not assist with the repair of the intensity measurement.

It would therefore be desirable to produce a new method of calculating an improved value for the exact mass and the intensity of mass spectral leaks to correct for the effects of dead time within the instrument.

One aspect of the present invention comprises a method of improving the fidelity of m/z dependent measurements for a species of interest in an analyte in a mass spectrometer, which method comprises the steps of acquiring raw data produced in a mass spectrometer, identifying a region within the raw data that relates to the species of interest, forming a mathematical model to calculate the joint probability distribution of the parameters effecting the m/z dependent measurements, analytically obtaining samples from the joint probability distribution to produce corrected or refined m/z dependent measurements with associated uncertainties. Preferably, the method corrects for deadtime. The mass spectrometer can utilise a TDC detector, The mass spectrometer can utilise an ADC detector.

Preferably, the method further comprises providing an analyte to a mass spectrometer and analysing said analyte in the mass spectrometer. Preferably the mass spectrometer is a time of flight [TOF] mass spectrometer and the m/z dependent measurements are flight time and/or arrival time measurements.

According to another feature of this aspect of the invention, the step of analytically obtaining samples from the joint probability distribution may be performed using a Markov chain monte carlo algorithm.

According to a further feature of this aspect of the invention the thus obtained samples may be used to produce so the required inferences including corrected ion arrival times and corrected intensity values together with associated uncertainties.

According to a still further feature of this aspect of the invention the joint probability distribution may be of the form:

$$Pr ( x , D , s , v ) = Pr ( v ) \frac{{\prod }_{{s}_{i} = 1}^{ } {p}_{i} {\prod }_{{s}_{j} = 0}^{ } ( 1 - {p}_{j} )}{{{w}^{{N}_{bad}} ( 2 π )}^{\frac{1}{2} ( {N}_{good} + 1 )} {σ}_{0} {\prod }_{{s}_{i} = 1}^{ } {σ}_{i}} exp - \frac{1}{2} ( {A}_{0} {ξ}^{2} - 2 {A}_{1} ξ + {A}_{2} )$$

$$where$$

$${N}_{good} = {\sum }_{i}^{ } {s}_{i} , {N}_{bad} = N - {N}_{good}$$

$${A}_{0} = \frac{1}{{σ}_{0}^{2}} + {\sum }_{{s}_{i} = 1}^{ } \frac{1}{{σ}_{i}^{2} } , {A}_{1} = \frac{{ξ}_{0}}{{σ}_{0}^{2}} + {\sum }_{{s}_{i} = 1}^{ } \frac{{x}_{i}^{′}}{{σ}_{i}^{2}} and {A}_{2} = \frac{{ξ}_{0}^{2}}{{σ}_{0}^{2}} + {\sum }_{{s}_{i} = 1}^{ } \frac{{x}_{i}^{′2}}{{σ}_{i}^{2}}$$

Another aspect of the invention provides a control system operative or programmed to execute a method according to any of the four immediately preceding paragraphs.

Another aspect of the invention provides apparatus for performing the method as defined in any of the relevant preceding paragraphs.

In a preferred embodiment of the current invention, corrections for hardware limitations is performed by the following procedure:
Identify the spectra and the range of arrival times containing ions of a particular species;
Peak detect the spectra thus identified;
Form a mathematical model relating the (unknown) effective number of experiments to the (unknown) underlying ion rates in each spectrum and the observed arrival times and the observed number of events in each spectrum. This allows calculation of the joint probability distribution of the unknown parameters (rates and effective number of experiments) and the data;
Use a Markov Chain Monte Carlo algorithm to obtain samples from this joint probability distribution;
Use these samples to produce the required inferences including corrected m/z dependent and or intensity measurements with associated uncertainties.

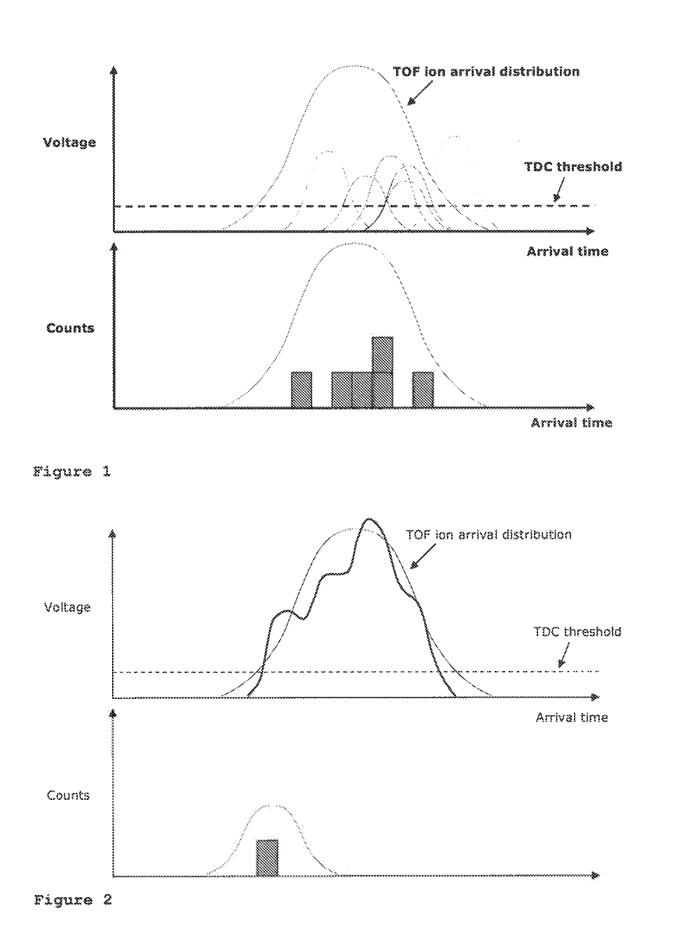

In the accompanying drawings, FIG. 1 shows a number of voltage pulses corresponding to single ion arrival events (shown on the top plot in red). In this case, the ion arrival times were recorded in separate experiments. The times at which the pulses rise past the TDC threshold are recorded in the histogram in the lower part of the Figure. It is clear that the shape of this histogram would eventually approach the depicted ion arrival distribution of the mass spectrometer albeit with a slight increase in width due to the distribution of pulse heights and an offset due to edge detection. The offset is removed by calibration.

Referring now to FIG. 2 of the accompanying drawings, this Figure shows the situation that occurs when several ions arrive in a single experiment. It is assumed that the detector is operating in a linear regime so that the responses from the individual ions simply sum. In this case, although there have clearly been many ion arrivals, the voltage crosses the TDC threshold in the upwards direction only once, and only one event is recorded in the histogram.

In this case, it is clear the histogram of ion detections that is built up over time approaches a distribution that is both smaller than the true ion arrival distribution (due to undercounting of ions) and is shifted to lower arrival times. These effects cannot be removed by ordinary mass calibration, since species that are close in mass and therefore in arrival time at the detector) may be affected to different degrees if their arrival rates differ.

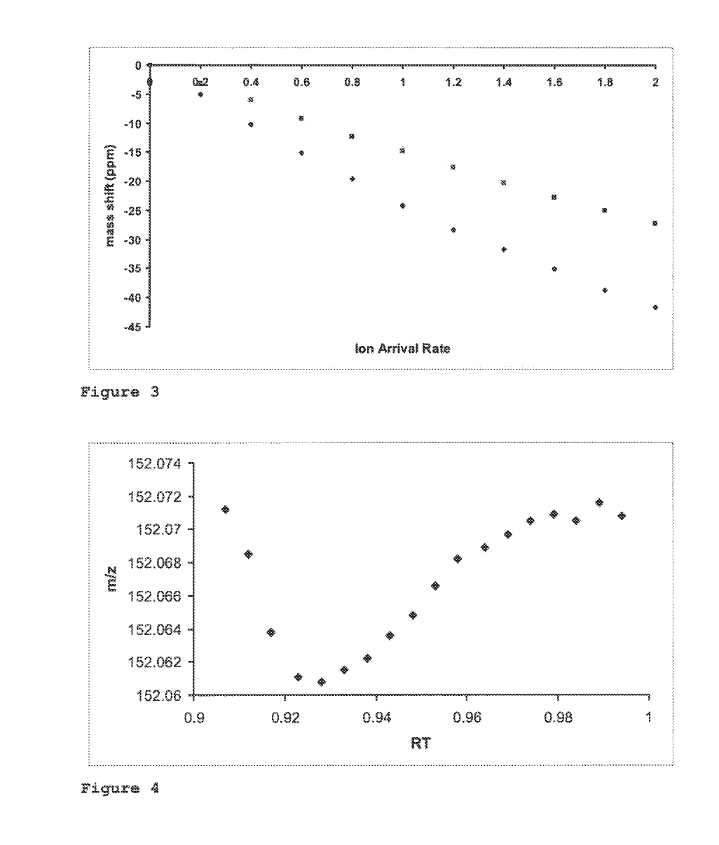

FIG. 3 of the accompanying drawings shows how the perturbation in mass measurement (expressed as parts per million) changes with ion arrival rate (expressed as the average number of ion arrivals per experiment) for a single species for a typical configuration of a time of flight mass spectrometer. The two sets of points correspond to two species of different mass. It is clear that, up to an ion arrival rate of two ions per experiment, the relationship between mass shift and ion arrival rate is approximately linear. The data for each point in this plot is an average obtained from many experiments.

FIG. 4 of the accompanying drawings shows how the mass measurement of the same species changes across a chromatographic peak as a result of the effects described above.

By experimental or theoretical investigation of the relationships depicted in FIG. 3, it is possible to build up a table of coefficients that can be applied to correct mass measurements at a known ion arrival rate. The relationship of the observed arrival rate to the actual arrival rate is often known, for example when ion arrivals follow a Poisson distribution and if it can be assumed that a maximum of one ion arrival can be observed for each species in a single experiment.

The recorded experimental data often consists of a sum of histograms obtained from hundreds or thousands of experiments.

For the purposes of the present invention, we shall refer to such a sum as a “spectrum”. A known method of deadtime correction has the following steps:

(i) Peaks are detected in the summed spectrum, recording the total number of detected events and a measured position for each peak;
(ii) The true ion arrival rate (average number of ions per experiment) for the species in question is inferred assuming that ion arrival times follow a Poisson is distribution and that a maximum of one ion can be detected per experiment; and
(iii) Using relationships already established experimentally or theoretically, the observed arrival time given the inferred rate is corrected.

This approach is useful when the ion arrival rate is constant during the time period over which experiments have been summed to produce the observed spectrum. However this condition is frequently not met and some examples of this are as follows:

In quadrupole time of flight (QTOF) instruments, ions first pass through a quadrupole mass filter and are subsequently subjected to time of flight mass analysis. It is common to scan the quadrupole during the acquisition of each spectrum to obtain transmission of a wider range of masses than is possible with any static quadrupole configuration.
Separation of ions on a timescale shorter than that of a spectrum but longer than that of an experiment can result in a different distribution of rates across experiments for each species. One example of this is ion mobility separation.
In experiments where chromatography is coupled to mass spectrometry, and the chromatographic peak width is comparable to the spectrum accumulation time, the ion arrival rate can vary significantly during the formation of a single spectrum.

A useful approximation is to consider the arrival rate to be constant, but allow for each species to experience an (a priori) effective number of experiments that is lower than the actual number of experiments used to form the spectrum. It will be assumed that the effective number of experiments is constant for a given species, although the underlying ion rate may change from spectrum to spectrum. The variation in ion rate may come about, for example, as a result of chromatography.

Assumptions, Approximations and Preconditions:

The data will be supplied as a list on N detected peaks. Each peak will have at least three attributes: position xᵢ, position uncertainty σᵢ and intensity Di.

For each peak, we assume that TDC effects can be corrected exactly via rᵢ¹=rᵢg(Dᵢ, N_{eff}) if N_{eff} is known precisely. N_{eff} may be lower than the nominal number of pushes due to MS Profile, collision energy ramping and a synchronicity. These effects are discussed elsewhere. Note that there is no reason for N_{eff} to be integer, so for later convenience we take introduce a parameter ν which a floating point number in (0,1), related to N_{eff} via

$$v = \frac{{N}_{eff} - {N}_{min}}{{N}_{max} - {N}_{min}} \qquad ( 1 )$$

where Nₘᵢₙ and Nₘₐₓ are the minimum and maximum possible number of pushes to be considered. ν is assumed to be constant within the ROI, but possibly unknown a priori. We do not make any assumptions about the functional form of g.

The peaks supplied as part as part of the ROI originate mainly from a single species with a true position lying in or near to the ROI.

Bayes' Theorem

The Bayesian view which has been adopted in relation to the present invention is that a consistent way of expressing and combining all sources of uncertainty is to use the standard rules of probability. In order to use this approach we must specify:

Prior probabilities—probability distributions for any unknown parameters.

A likelihood function—a probability distribution for the data given values for the unknown parameters.

We may then invoke Bayes' theorem to find the posterior probability distribution for the model parameters:

$$Posterior = \frac{Likelihood \cdot Prior}{Evidence} = \frac{Joint}{Evidence} \qquad ( 2 )$$

To further illustrate a specific embodiment of the invention, preferred method of performing the invention shall now be disclosed, this is one way of performing the invention, and should not be understood to encompass the full scope of the inventive concept.

Parameters and Prior:

The principal aim of the algorithm is to make inferences about the true position ζ. A Gaussian prior is assigned for ζ with mean ζ0 and standard deviation σ0, ζ0 and σ0 should be supplied, although a simple assignment based on the position and width w of The ROI should be adequate. It would be apparent to a person skilled in the art that any one of numerous priors could be assigned.

Each of The supplied peaks may be ‘good’ (originating from the species of interest) or ‘bad’ (a contaminant), We therefore introduce one parameter sᵢ for each peak which takes the value sᵢ=1 if the peak is ‘good’ or sᵢ=0 if it ‘bad’ , Each peak is assigned a prior probability pᵢ=Pr (sᵢ=1), These values could be the result of prior analysis of the ROI but a simple assignment such as pᵢ=0.9 is usually sufficient, indicating that we expect most of the data to be relevant.

We assume that a prior probability function Pr (ν) is specified and that we can obtain samples from it efficiently. If ν is known to have the value ν₀ then we simply assign Pr (ν)=δ (ν−ν₀).

Combining the above contributions gives the complete prior:

$$Pr ( s , ξ , v ) = Pr ( v ) \frac{1}{\sqrt{2 π} {σ}_{0}} exp - \frac{{( ξ - {ξ}_{0} )}^{2}}{2 {σ}_{0}^{2}} {\prod }_{{s}_{i} = 1}^{ } {p}_{i} {\prod }_{{s}_{j} = 0}^{ } ( 1 - {p}_{j} ) . \qquad ( 3 )$$

Where s is the vector of ‘good’/‘bad’ states.

Likelihood:

The contribution to the likelihood from a single datum is as follows:

$$Pr ( {x}_{i} \vert {D}_{i} , {s}_{i} = 1 , ξ , v ) = \frac{1}{\sqrt{2 π} {σ}_{i}} exp - \frac{{( {x}_{i}^{′} - ξ )}^{2}}{2 {σ}_{i}^{2}} \\ Pr ( {x}_{i} \vert {D}_{i} , {s}_{i} = 0 , ξ , v ) = \frac{1}{w} \qquad ( 4 )$$

where it has been assumed that the ion arrival rate implied by the observed number of counts (given a choice for v) determines the shift in position measurement due to deadtime with sufficient accuracy for present purposes. This assumption can be relaxed at the cost of introducing an extra nuisance parameter corresponding to the underlying true ion arrival rate.

Where rᵢ¹=rᵢg(xᵢ,Dᵢ, ν) is the corrected position and w is the width of the ROI. If a peak is ‘good’ then we expect it to lie close to the true position (top line), whereas if it is ‘bad’ then it could lie anywhere in the ROI (bottom line). It would be apparent to a person skilled in the art that any one of numerous methods of assigning the likelihood could be used.

Joint Probability:

Multiplying the prior by the likelihood for each datum gives the joint probability of the data and parameters:

$$\begin{matrix}Pr ( x , D , s , ξ , v ) = Pr ( v ) \frac{{\prod }_{{s}_{i} = 1}^{ } {p}_{i} {\prod }_{{s}_{j} = 0}^{ } ( 1 - {p}_{j} )}{{{w}^{{N}_{bad}} ( 2 π )}^{\frac{1}{2} ( {N}_{good} + 1 )} {σ}_{0} {\prod }_{{s}_{i} = 1}^{ } {σ}_{i}} exp - \frac{1}{2} ( {A}_{0} {ξ}^{2} - 2 {A}_{1} ξ + {A}_{2} ) , & ( 5 ) \\ where \\ {N}_{good} = {\sum }_{i}^{ } {s}_{i} , {N}_{bad} = N - {N}_{good} , & \\ {A}_{0} = \frac{1}{{σ}_{0}^{2}} + {\sum }_{{s}_{i} = 1}^{ } \frac{1}{{σ}_{i}^{2}} , {A}_{1} = \frac{{ξ}_{0}}{{σ}_{0}^{2}} + {\sum }_{{s}_{i} = 1}^{ } \frac{{x}_{i}^{′}}{{σ}_{i}^{2}} and {A}_{2} = \frac{{ξ}_{0}^{2}}{{σ}_{0}^{2}} + {\sum }_{{s}_{i} = 1}^{ } \frac{{{x}^{′}}_{i}^{2}}{{σ}_{i}^{2}} . & ( 6 )\end{matrix}$$

One method of extracting statistics of quantities of interest from a joint probability distribution (which may have a number of nuisance variables not or immediate interest) is to take samples from it which are faithful to the distribution. One widely applicable method of achieving this is to use an MCMC method and record samples of the quantities of interest. In addition,
1. Exact analytic integration might be possible.
2. A sufficiently good analytic approximation might be feasible.
3. Location of a maximum followed by Gaussian approximation about that maximum might be possible (Laplace's method—Mackay, 2005, Information Theory, Inference and Learning Algorithms, Chapter 27)
4. Combinations of (2), (3) and (4) might allow all nuisance variables to be eliminated.

Other methods of obtaining the desired statistics could involve taking samples which are not faithful to the probability distribution but which may be weighted before combination to obtain estimates which are faithful. Examples include
1. Importance sampling (Mackay, 2005. Information Theory,

Inference and Learning Algorithms, Chapter 29)
2. Nested sampling (Sivia and Skilling, J. 2006. Data Analysis: A Bayesian Tutorial, 2nd Edition)

Although the invention disclosed is described with particular reference to edge detecting ion detectors such as time to digital converters (TDC), it is recognised that this approach is applicable to other ion detection devices.

For example, when using analogue to digital converters (ADC), ion arrival rate dependent mass shifts and intensity distortions are also observed. These mass shifts may be due to the intensity of the signal to be digitised exceeding the dynamic range of the ADC. For example, considering an eight bit ADC, if the digitised signal within a single time of flight spectrum exceeds 255 least significant bits both the signal intensity and calculated arrival time will be distorted. The ADC is said to be in saturation.

A theoretical or experimental approach may be taken to determine the relationship between ion arrival rate and m/z shift and signal response for a system using an ADC. The information may be used to improve the measurement of m/z and response using the methods described.

Other sources of m/z or response distortion may be considered. For example distortion may be caused by intensity related bandwidth changes associated with electronic components, such as amplifiers, in the signal path.

In addition, m/z or response distortion may arise from electron multiplier or photomultiplier saturation. Many mass spectrometers employ an electron multiplier to amplify the signal response. For example, Microchannel Plate Detectors (MCP) are commonly used in time of flight mass spectrometers. Electron multipliers have a limited maximum output current beyond which distortion of the signal may occur. At this point the detector is said to be in saturation.

It will be appreciated by those skilled in the art that any number of combinations of the aforementioned features and/or those shown in the appended drawings provide clear advantages over the prior art and are therefore within the scope of the invention described herein.

1. A method of improving the fidelity of m/z dependent measurements for a species of interest in an analyte in a mass spectrometer, which method comprises the steps of acquiring raw data produced in a mass spectrometer, identifying a region within the raw data that relates to the species of interest, forming a mathematical model to calculate the joint probability distribution of the parameters effecting the m/z dependent measurements, analytically obtaining samples from the joint probability distribution to produce corrected or refined m/z dependent measurements with associated uncertainties.

2. A method as claimed in claim 1, wherein the method corrects for deadtime.

3. A method as claimed in claim 1, wherein the mass spectrometer utilises a TDC detector.

4. A method as claimed in claim 1, wherein the mass spectrometer utilises an ADC detector.

5. A method according to any claim 1, wherein said method further comprises providing an analyte to a mass spectrometer and analysing said analyte in the mass spectrometer

6. A method according to claim 5 wherein the mass spectrometer is a time of flight [TOF] mass spectrometer and the m/z dependent measurements are flight time and/or arrival time measurements.

7. A method according to claim 1 wherein the step of analytically obtaining samples from the joint probability distribution is performed using a Markov chain monte carlo algorithm.

8. A method according to claim 1 wherein the thus obtained samples are used to produce the required inferences including corrected ion arrival times and corrected intensity values together with associated uncertainties.

9. A method according to claim 1 wherein the joint probability distribution is of the form:
$$Pr ( x , D , s , ξ , v ) = Pr ( v ) \frac{{\prod }_{{s}_{i} = 1}^{ } {p}_{i} {\prod }_{{s}_{j} = 0}^{ } ( 1 - {p}_{j} )}{{{w}^{{N}_{bad}} ( 2 π )}^{\frac{1}{2} ( {N}_{good} + 1 )} {σ}_{0} {\prod }_{{s}_{i} = 1}^{ } {σ}_{i}} exp - \frac{1}{2} ( {A}_{0} {ξ}^{2} - 2 {A}_{1} ξ + {A}_{2} )$$
$$where$$
$${N}_{good} = {\sum }_{i}^{ } {s}_{i} , {N}_{bad} = N - {N}_{good}$$
$${A}_{0} = \frac{1}{{σ}_{0}^{2}} + {\sum }_{{s}_{i} = 1}^{ } \frac{1}{{σ}_{i}^{2}} , {A}_{1} = \frac{{ξ}_{0}}{{σ}_{0}^{2}} + {\sum }_{{s}_{i} = 1}^{ } \frac{{x}_{i}^{′}}{{σ}_{i}^{2}} and {A}_{2} = \frac{{ξ}_{0}^{2}}{{σ}_{0}^{2}} + {\sum }_{{s}_{i} = 1}^{ } \frac{{{x}^{′}}_{i}^{2}}{{σ}_{i}^{2}}$$

10. A control system operative or programmed to execute the method of claim 1.

11. Apparatus for performing the method of claim 1.
